(19) United States
(12) Patent Application Publication
(10) Pub. No.: US 2009/0016815 A1
(43) Pub. Date: Jan. 15, 2009

(54) Hand rail return construction

(76) Inventor: Robert F. Moore, Sandusky, MI (US)

Correspondence Address: ROBERT F. MOORE, 178 W. CUSTER ROAD, SANDUSKY, MI, 48471, US

(21) Appl. No.: 11/827,349

(22) Filed: Jul. 11, 2007

(51) Int. Cl. F16D 1/02

(52) U.S. Cl. 403/300

(57) ABSTRACT

A hand rail adapted for mounting on a wall and having free ends spaced from such wall, and a coupling between the free, opposite ends of the rail for supporting return members which span the space between the rail and the wall surface. Each coupling has a socket at each end thereof, one of such sockets being adapted for the accommodation of the free end of the rail and the other of such sockets being adopted for the accommodation of a free end of the return member. Each socket has an inner surface which tapers in a direction inwardly of the coupling and also has an internal shoulder which limits the extent to which the rail or return member may extend into the coupling.

This invention relates to a return construction adapted for use with a hand rail mounted on and spaced from a wall, the return closing the space between the wall and the rail at the ends of the latter.

### BACKGROUND OF THE INVENTION

A hand rail conventionally is provided for the purpose of enabling a person to obtain support when necessary or desirable. A hand rail conventionally is installed on a wall alongside a staircase, for example, so as to extend at an angle to the horizontal corresponding to the angle at which the staircase is formed. It also is conventional to install a hand rail in a horizontal position so as to extend alongside a corridor wall. It has been conventional for many years to install a hand rail on a wall by means of mounting brackets secured both to the wall and to the rail at spaced intervals so that the rail occupies a position spaced from the wall a distance sufficient to enable a person's fingers to enter the space and grip the hand rail.

For many years it was conventional to cut the rail to a desired length, secure it to the wall, and leave the ends of the rail free of any attachments. Such an arrangement has been criticized because loose clothing or equipment, such as that carried by a fire fighter, for example, could enter the space between the wall and the hand rail at either end of the latter, thereby creating a potentially hazardous condition.

It now is mandated by safety codes in many jurisdictions that the space between a wall and a hand rail at opposite ends of the latter be closed so as to avoid the likelihood of clothing or equipment entering such space.

In order to close the space between a wall and a hand rail at opposite ends of the latter it has been conventional to install what is known as return member which is joined to the free end of the rail and extends toward and abuts the wall on which the rail is mounted.

When a return member is to be joined to the free end of a hand rail, it is conventional to miter the free end of the rail and one of the ends of the return member and then glue or otherwise secure the return member to the rail, thereby providing a smooth joint between the two. However, the mitering produces sharp edges between the rail and the return member which are prone to being splintered. In those instances in which the mitered return member is screwed or otherwise mechanically joined to the mitered end of the rail, the insertion of the screw sometimes splits the rail end and/or the return member end, thereby producing scrap.

A conventional hand rail has upper and side surfaces which are arcuate or otherwise shaped and include a flat surface at that side of the rail which will face downwardly when the rail is installed on a wall. Such flat surface provides a seat for one end of a mounting bracket, the opposite end of which is secured to the wall.

In those instances in which the hand rail is secured to a wall alongside a staircase, the rail is inclined to the horizontal at an angle corresponding to that at which the stair case extends. In such a case the return member when installed should be so formed that it presents an appearance corresponding as much as possible to that of the hand rail. That is, the return member should have a flat surface which faces downwardly so that such flat surface is not objectionably visible. In conventional cases in which the confronting ends of the rail and return are mitered, joining of the return to the free end of the hand rail requires for a substantial period of time the services of a highly skilled carpenter.

A principal object of the invention is to provide a coupling for facilitating the joining of one end of the hand rail to a return member.

### SUMMARY OF THE INVENTION

Apparatus constructed in accordance with the invention for joining a return member to a hand rail comprises an angular coupling having two body sections each of which terminates in a socket. One socket is adapted to accommodate a free end of a hand rail and the other socket is adapted to accommodate a free end of a return member which spans the distance between the hand rail and a wall on which the hand rail is mounted. Each socket has an inner shoulder adapted to engage the free end of the rail member or return member and thereby limit the extent to which such member may extend into its associated socket. That socket which is intended to accommodate the free end of the rail member has a seating surface corresponding to the seating surface of the rail to which a mounting bracket may be attached. The socket adapted to accommodate one end of the return member has a similar seating surface corresponding to that of the return member. In those instances in which the hand rail is intended to occupy an installed position inclined to the horizontal, the return member seating surface of the return-accommodating socket is inclined to the horizontal at an angle corresponding substantially to the angle at which the rail member is inclined to the horizontal, thereby enabling the return member to present an installed visual appearance corresponding to that presented by the rail.

Each socket has an opening in communication therewith for the accommodation of a securing screw or the like by means of which the socket may be secured to the hand rail and to the return member.

### THE DRAWINGS

Apparatus constructed in accordance with preferred embodiments of the invention is illustrated in the accompanying drawings wherein:

FIG. 1 is a fragmentary, isometric view illustrating a hand rail supported on a wall adjacent a staircase and provided at each of its opposite ends with a return member;

FIG. 2 is a top plan view, partly in section, of the apparatus;

FIG. 3 is a cross sectional view of one conventional style hand rail;

FIG. 4 is a sectional view of a second conventional style hand rail;

FIG. 5 is a bottom plan view, on an enlarged scale, of a right angular coupling;

FIG. 6 is an isometric view of the coupling shown in FIG. 5;

FIG. 7 is sectional view, on a reduced scale, taken on the line 7-7 of FIG. 6; and

FIG. 8 is a view similar to FIG. 2, but illustrating a modified form of coupling.

### THE PREFERRED EMBODIMENTS

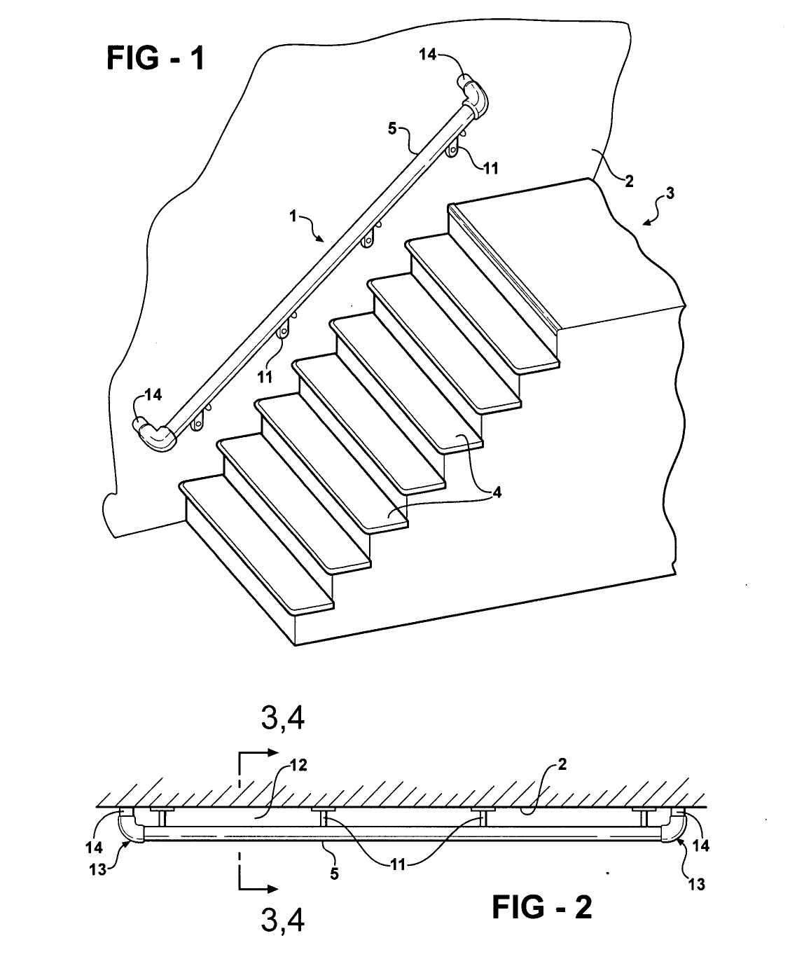

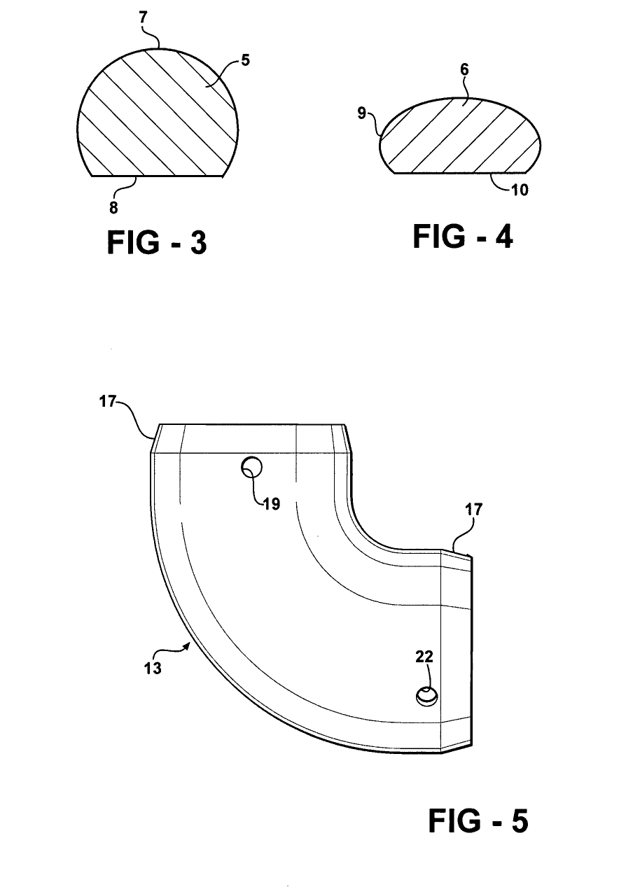

Apparatus constructed in accordance with the invention is adapted for use with a hand rail 1 of conventional construction mounted on a wall 2 alongside a staircase 3 having a plurality of steps 4, the staircase being inclined with respect to a horizontal plane. The hand rail may have any selected configuration two of the currently most common of which are shown at 5 and 6 in FIGS. 3 and 4. The rail 5 has a smoothly rounded, arcuate surface 7 and a flat seating surface 8 at one side thereof. The rail 6 has a smoothly rounded arcuate surface 9 which is different from that shown in FIG. 3, but the rail 6 also has at one side thereof a flat seating surface 10. For purposes of illustration the hand rail shown in FIGS. 1 and 2 corresponds in configuration to the hand rail 5.

The length of the hand rail 5 is sufficient to extend the required distance alongside the staircase and terminates in free ends which have end surfaces which are perpendicular to the longitudinal axis of the rail. The ends of the hand rail need not be mitered or otherwise modified. The hand rail 5 is mounted on the wall 2 by a plurality of mounting brackets 11 each of which has an arm which seats on the flat seating surface 8 of the rail and is secured thereto by suitable means such as screws (not shown). The brackets 11 mount the rail 5 parallel to the surface of the wall 2, but at a selected distance therefrom so as to provide a space 12 in which the fingers of a user may be accommodated as the user ascends or descends the staircase. The mounting apparatus thus far described is conventional.

At each end of the hand rail is a coupling 13 which provides support for a return member 14 which spans the space between the wall surface and the rail 5 and has a cross sectional configuration corresponding to that of the hand rail with which the return is to be used. Each coupling 13 has a tubular body forming two angular sections each of which terminate in a socket 15. The wall of each socket tapers 2°-4° in a direction inwardly of the body and terminates in a shoulder 16. The taper counteracts shrinkage which may affect a rail formed of wood. The outer surface at each opposite end of the coupling preferably is chamfered as shown at 17.

That end of the coupling which is adapted to accommodate one end of the rail 5 has a flat surface 18 on which the mounting surface 8 of the rail is adapted to seat. An opening 19 extends from the exterior of the coupling through the seating surface 18 for the accommodation of a securing screw (not shown) or any other appropriate device for securing the coupling to the rail. The opposite end of the coupling is adapted to accommodate one end of the return member 14 and has a flat surface 20 on which the flat mounting surface of the return 14 may seat. An opening 22 similar to the opening 19 is provided for accommodation of a securing screw or the like (not shown).

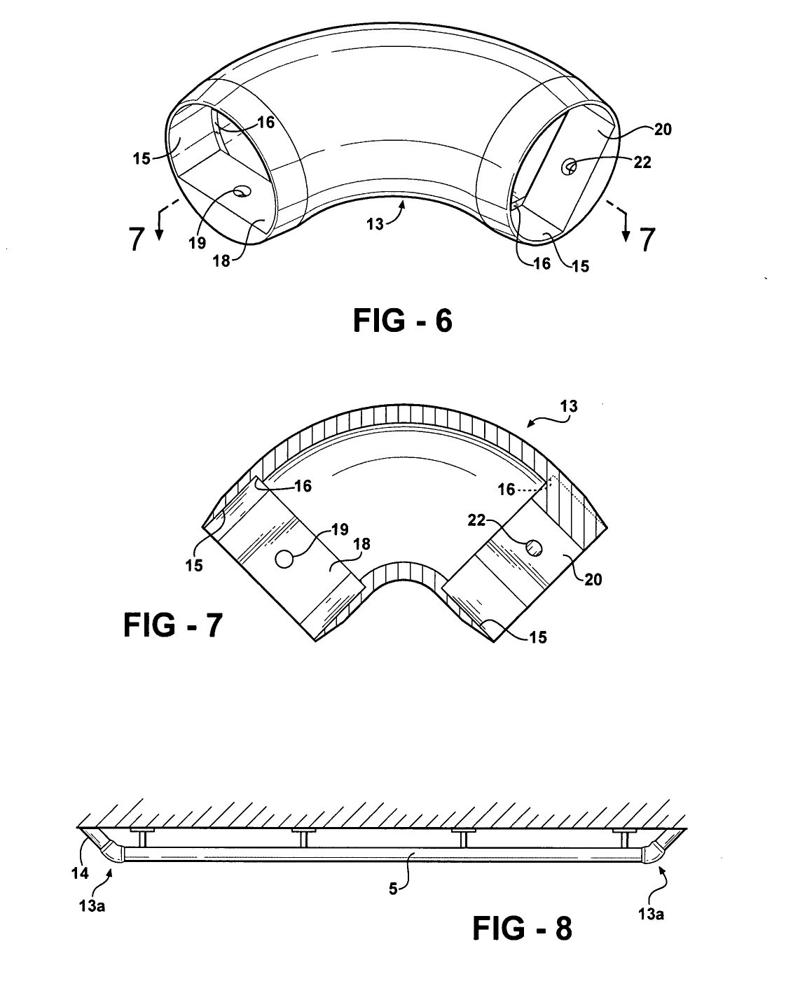

As is best shown in FIG. 6, the seating surface 20 is oriented to the seating surface 18 at an angle which corresponds to that at which the hand rail 5 is inclined to the horizontal. Accordingly, when one end of the return member 14 is accommodated in the socket 15, the flat mounting surface of the return member 14 will face downwardly as does the mounting surface 8 of the rail 5. Therefore, the appearance of the hand rail and the appearance of the return member will correspond, even though the longitudinal axis of the return member is parallel to a horizontal plane and the longitudinal axis of the hand rail is inclined to such plane.

The cross sectional configuration of the ends of the coupling 13 corresponds to that of the rail 5 shown in FIG. 3. However, if a rail has the cross sectional configuration shown in FIG. 4, or any other configuration, the cross sectional configuration of the opposite ends of the coupling should correspond.

The embodiment shown in FIG. 8 is substantially the same as the earlier described embodiment, but differs from the latter in that the angular sections of each coupling member 13a form an obtuse angle, rather than an acute angle. In all other respects the embodiment of FIG. 8 is the same as that described earlier.

Use of the coupling members 13, 13a dispenses with the necessity of mitering the ends of the rail and return members, thereby greatly facilitating the attachment of the return members to the rail. The use of the coupling members also avoids the necessity of cutting the ends of the rail so that the surfaces of such ends parallel a vertical plane. Nevertheless, the space between the ends of the rail and the wall will be spanned by the return members, thereby avoiding the possibility of snagging a person's clothing or equipment.

To provide a finished appearance the coupling member may be formed of plastic material colored or painted to correspond to the color of the rail.

Coupling apparatus corresponding to that disclosed herein is usable not only with new construction, but also may be retrofitted to existing hand rail installations, thereby enabling existing rails to conform to safety codes.

The disclosed embodiments are representative of presently preferred forms of the invention, but are intended to be illustrative rather than definitive thereof. The invention is defined in the claims.

I claim:

1. A hand rail construction comprising an elongate rail having a selected cross sectional configuration including a substantially flat mounting surface; mounting means for mounting said rail adjacent a wall with a space between said rail and said wall and with said mounting surface facing a selected direction; a return member at least at one end of said rail for spanning the space between said wall and said rail, said return member having a substantially flat surface along one side thereof; and angular coupling means joining said rail and said return member, said coupling means having at one end thereof a first socket accommodating said one end of said rail and at another end thereof a second socket for accommodating one end of said return member in a position to span said space, said first socket having a first flat mounting surface the orientation of which corresponds to that of the flat mounting surface of said rail, and said second socket having a flat mounting surface so orientated with respect to said return member as to be substantially parallel thereto.

2. The construction according to claim 1 wherein said coupling means is so configured that said first and second sockets extend at an acute angle with respect to one another.

3. The construction according to claim 1 wherein said coupling means is so configured that said first and second sockets extend at an obtuse angle with respect to one another.

4. The construction according to claim 1 wherein each of said sockets is tapered in a direction inwardly of said coupling means.

5. The construction according to claim 1 wherein each said socket has in internal shoulder at its inner end.

6. A coupling for supporting a return member and one end of a hand rail supported by a wall and spaced from said wall by a finger accommodating space, said coupling comprising a body member having two angularly extending sections, one of said sections having a first socket for the accommodation of said one end of said rail and the other of said sections having a second socket for the accommodation of one end of said return member, said first socket having a cross sectional configuration corresponding to that of said one end of said rail, said second socket having a cross sectional configuration corresponding to that of said return member, and each of said sockets tapering in a direction inwardly of said coupling member.

7. The coupling according to claim 6 wherein the cross sectional configuration of each of said sockets includes a flat surface in a position to engage a corresponding surface of said rail and said return member, respectively.

8. The coupling according to claim 6 wherein the sections of said body member together form an acute angle.

9. A coupling according to claim 6 wherein the sections of said body member together form an obtuse angle.

10. A coupling for use with a hand rail secured to a wall at a spaced distance from and extending alongside said wall at an inclination to a horizontal plane, said coupling comprising a body having two sections forming an angle therebetween, each of said sections terminating in a socket one of which is for the accommodation of one end of said rail and the other of which is for the accommodation of a return member of such length as to span the distance between said rail and said wall, each of said rail and said return member having at one end thereof a downwardly facing flat mounting surface, the socket for the accommodation of said one end of said rail having a flat surface on which the flat surface of said rail may seat and the socket for the accommodation of said return member having a flat surface on which said return member may rest, the flat surface of said second socket being angularly displaced from the flat surface of said first socket by an amount corresponding substantially to the angle of inclination of said hand rail to said horizontal plane.

11. The coupling according to claim 10 wherein each of said socket tapers in a direction inwardly of said body.

12. The coupling according to claim 10 wherein the angle formed by said sections of said body is acute.

13. The coupling according to claim 10 wherein the angle formed by said sections of said body is obtuse.

14. The coupling according to claim 10 wherein each said section of said body has an opening therein for the accommodation of means for securing said body to said rail and to said return member.

15. The coupling according to claim 10 including anchor means for securing said coupling to each of said hand rail and said return member.
